(19) United States
(12) Patent Application Publication
(10) Pub. No.: US 2025/0070972 A1
(43) Pub. Date: Feb. 27, 2025

(54) SYSTEM AND METHOD FOR COMPUTING MODERN CRYPTOGRAPHIC PRIMITIVES WITH CLASSIC CRYPTOGRAPHIC INTERFACES

(71) Applicant: NXP B.V., Eindhoven (NL)

(72) Inventors: Mario Lamberger, Graz (AT); Laurie Genelle, Graz (AT)

(21) Appl. No.: 18/449,355

(22) Filed: Aug. 14, 2023

(51) Int. Cl. H04L 9/30

(52) U.S. Cl. CPC H04L 9/3066

(57) ABSTRACT

A method for carrying out an elliptic curve based cryptographic operation using a cryptographic processor with a first elliptic curve and α fixed interface, including: converting a second point on a second elliptic curve to a first point on the first elliptic curve using a first function interface of the cryptographic processor and a second function interface of the cryptographic processor; performing a point multiplication on the first point to produce a third point on the first elliptic curve using a point multiplication interface of the cryptographic processor; and converting the third point on the first elliptic curve to a fourth point on the second elliptic curve using the first function interface of the cryptographic processor and the second function interface of the cryptographic processor, wherein the first function interface of the cryptographic processor computes r+h·d mod n and the second function interface of the cryptographic processor computes x⁻¹ mod n.

### FIELD OF THE DISCLOSURE

Various exemplary embodiments disclosed herein relate to systems and methods for computing modern cryptographic primitives with classic cryptographic interfaces.

### BACKGROUND

Montgomery curve based elliptic curve primitives and twisted Edwards curve based primitives are important new cryptographic primitives that have been standardized by IETF RFC 8032 and RFC 7748 and recently also in FIPS 186-5 and SP800-186. Both are taking state-of-the-art cryptographic developments into account that were not available in 1999 when the first NIST ECC parameters came out. Currently, most of the devices are still implementing and including hardware support for these classical Weierstrass parameters and uptake of the new parameters together with dedicated hardware support and countermeasures will take time.

### SUMMARY

A summary of various exemplary embodiments is presented below.

A method for carrying out an elliptic curve based cryptographic operation using a cryptographic processor with a fixed interface, wherein the cryptographic processor uses a first elliptic curve, including: converting a second point on a second elliptic curve to a first point on the first elliptic curve using a first function interface of the cryptographic processor and a second function interface of the cryptographic processor; performing a point multiplication on the first point to produce a third point on the first elliptic curve using a point multiplication interface of the cryptographic processor; and converting the third point on the first elliptic curve to a fourth point on the second elliptic curve using the first function interface of the cryptographic processor and the second function interface of the cryptographic processor, wherein the first function interface of the cryptographic processor computes r+h·d mod n where, r, h, d, and n are input values to the first function interface, and wherein the second function interface of the cryptographic processor computes x⁻¹ mod n, where x is an input value to the second function interface.

Various embodiments are described, wherein the first elliptic curve is a Weierstrass elliptic curve and the second elliptic curve is a Montgomery curve.

Various embodiments are described, wherein converting the second point on the second elliptic curve to the first point on the first elliptic curve includes calculating

$${x}_{w} = \frac{{x}_{m}}{{B}_{m}} + \frac{{A}_{m}}{3 {B}_{m}}$$

$${y}_{w} = \frac{{y}_{m}}{{B}_{m}}$$

where x_{w} and y_{w} are the x and y coordinates of the first point on the Weierstrass curve, xₘ and yₘ are the x and y coordinates of the second point on the Montgomery curve and Aₘ and Bₘ are parameters of the Montgomery curve.

Various embodiments are described, wherein computing

$${x}_{w} = \frac{{x}_{m}}{{B}_{m}} + \frac{{A}_{m}}{3 {B}_{m}}$$

$${y}_{w} = \frac{{y}_{m}}{{B}_{m}}$$

$$includes computing$$

$$PublicInv ( {B}_{m} , p ) = {B}_{m}^{- 1} mod p$$

$$PublicInv ( 3 , p ) = {3}^{- 1} mod p$$

$$PublicArith ( 0 , {3}^{- 1} , {B}_{m}^{- 1} , p ) = {( 3 \cdot {B}_{m} )}^{- 1} mod p$$

$$PublicArith ( 0 , {A}_{m} , {( 3 {B}_{m} )}^{- 1} , p ) = {A}_{m} \cdot {( 3 \cdot {B}_{m} )}^{- 1} mod p$$

$$PublicArith ( {A}_{m} \cdot {( 3 \cdot {B}_{m} )}^{- 1} , x ( {P}_{m} ) , {B}_{m}^{- 1} , p ) = x ( {P}_{w} )$$

$$PublicArith ( 0 , y ( {P}_{m} ) , {B}_{m}^{- 1} , p ) = y ( {P}_{w} )$$

where PublicInv(x,n) computes x⁻¹ mod n, PublicArith(r,h,d,n) computes r+h·d mod n, x(P_{w}) is x_{w}, and y(P_{w}) is y_{w}.

Various embodiments are described, wherein converting the third point on the first elliptic curve to the fourth point on the second elliptic curve includes calculating

$${x}_{m} = {B}_{m} \cdot {x}_{w} - \frac{{A}_{m}}{3}$$

$${y}_{m} = {B}_{m} \cdot {y}_{w}$$

where x_{w} and y_{w} are the x and y coordinates of the first point on the Weierstrass curve, xₘ and yₘ are the x and y coordinates of the second point on the Montgomery curve and Aₘ and Bₘ are parameters of the Montgomery curve.

Various embodiments are described, wherein computing

$$\begin{matrix}{x}_{m} = {B}_{m} \cdot {x}_{w} - \frac{{A}_{m}}{3} \\ {y}_{m} = {B}_{m} \cdot {y}_{w}\end{matrix}$$

$$includes computing$$

$$\begin{matrix}PublicArith ( 0 , - 1 , {A}_{m} , p ) = - {A}_{m} mod p \\ PublicArith ( 0 , - {A}_{m} , {3}^{- 1} , p ) = - {A}_{m} \cdot {3}^{- 1} mod p \\ PublicArith ( - {A}_{m} \cdot {3}^{- 1} , x ( {Q}_{w} ) , {B}_{m} , p ) = x ( {Q}_{m} ) \\ PublicArith ( 0 , y ( {Q}_{w} ) , {B}_{m} , p ) = y ( {Q}_{m} )\end{matrix}$$

where PublicInv(x,n) computes x⁻¹ mod n, PublicArith(r,h,d,n) computes r+h·d mod n, x(Pₘ) is xₘ, and y(Pₘ) is yₘ.

Various embodiments are described, wherein performing a point multiplication on the first point to produce the third point on the first elliptic curve includes calculating

$${Q}_{w} = r \cdot {P}_{w}$$

where Q_{w} is the third point on the first elliptic curve, P_{w} is the first point on the first elliptic curve, and r is a scalar multiplication value.

Various embodiments are described, further including: converting a fifth point on a third elliptic curve to the second point on the second elliptic curve using the first function interface of the cryptographic processor and the second function interface of the cryptographic processor; and converting the fourth point on the second elliptic curve to a sixth point on the third elliptic curve using the first function interface of the cryptographic processor and the second function interface of the cryptographic processor.

Various embodiments are described, wherein the first elliptic curve is a Weierstrass elliptic curve, the second elliptic curve is a Montgomery elliptic curve, and the third elliptic curve is a Edwards elliptic curve.

Various embodiments are described, wherein converting the fifth point on a third elliptic curve to the second point on the second elliptic curve includes calculating

$$\begin{matrix}{x}_{m} = \frac{1 + {y}_{e}}{1 - {y}_{e}} \\ {y}_{m} = α \cdot \frac{{x}_{m}}{{x}_{e}}\end{matrix}$$

where xₑ and yₑ are the x and y coordinates of the fifth point on the Edwards elliptic curve, xₘ and yₘ are the x and y coordinates of the second point on the Montgomery elliptic curve and α is a parameter based upon the parameters of the Montgomery and Edwards elliptic curves.

Various embodiments are described, wherein computing

$$\begin{matrix}{x}_{m} = \frac{1 + {y}_{e}}{1 - {y}_{e}} \\ {y}_{m} = α \cdot \frac{{x}_{m}}{{x}_{e}}\end{matrix}$$

$$includes computing$$

$$\begin{matrix}PublicArith ( 1 , - 1 , y ( {P}_{e} ) , p ) = 1 - y ( {P}_{e} ) mod p \\ PublicArith ( 1 , 1 , y ( {P}_{e} ) , p ) = 1 + y ( {P}_{e} ) mod p \\ PublicInv ( 1 - y ( {P}_{e} ) , p ) = {( 1 - y ( {P}_{e} ) )}^{- 1} mod p \\ PublicArith ( 0 , 1 + y ( {P}_{e} ) , {( 1 - y ( {P}_{e} ) )}^{- 1} , p ) = ( 1 + y ( {P}_{e} ) ) {( 1 - y ( {P}_{e} ) )}^{- 1} mod p = x ( {P}_{m} ) \\ PublicArith ( 0 , x ( {P}_{m} ) , {x ( {P}_{e} )}^{- 1} , p ) = x ( {P}_{m} ) \cdot {( x ( {P}_{e} ) )}^{- 1} mod p \\ PublicArith ( 0 , α , x ( {P}_{m} ) \cdot {( x ( {P}_{e} ) )}^{- 1} , p ) = y ( {P}_{m} )\end{matrix}$$

where PublicInv(x,n) computes x⁻¹ mod n, PublicArith(r,h,d,n) computes r+h·d mod n, x(Pₘ) is x_{w}, and y(Pₘ) is yₘ.

Various embodiments are described, wherein converting the fourth point on the second elliptic curve to a sixth point on the third elliptic curve includes calculating

$$\begin{matrix}{x}_{e} = α \cdot \frac{{x}_{m}}{{y}_{m}} \\ {y}_{e} = \frac{{x}_{m} - 1}{{x}_{m} + 1}\end{matrix}$$

where xₑ and yₑ are the x and y coordinates of the first point on the Edwards elliptic curve, xₘ and yₘ are the x and y coordinates of the second point on the Montgomery elliptic curve, and α is a parameter based upon the parameters of the Montgomery and Edwards elliptic curves.

Various embodiments are described, wherein computing

$$\begin{matrix}{x}_{e} = α \cdot \frac{{x}_{m}}{{y}_{m}} \\ {y}_{e} = \frac{{x}_{m} - 1}{{x}_{m} + 1}\end{matrix}$$

$$includes computing$$

$$\begin{matrix}PublicInv ( y ( {Q}_{m} ) , p ) = {y ( {Q}_{m} )}^{- 1} mod p \\ PublicArith ( 0 , {y ( {Q}_{m} )}^{- 1} , x ( {Q}_{m} ) , p ) = \frac{x ( {Q}_{m} )}{y ( {Q}_{m} )} \\ PublicArith ( 0 , α , x ( {Q}_{m} ) {y ( {Q}_{m} )}^{- 1} , p ) = \frac{α x ( {Q}_{m} )}{y ( {Q}_{m} )} = x ( {Q}_{e} ) \\ PublicArith ( - 1 , 1 , x ( {Q}_{m} ) , p ) = x ( {Q}_{m} ) - 1 mod p \\ PublicArith ( 1 , 1 , x ( {Q}_{m} ) , p ) = x ( {Q}_{m} ) + 1 mod p \\ PublicInv ( x ( {Q}_{m} ) + 1 , p ) = {( x ( {Q}_{m} ) + 1 )}^{- 1} mod p \\ PublicArith ( 0 , {( x ( {Q}_{m} ) + 1 )}^{- 1} , x ( {Q}_{m} ) - 1 , p ) = y ( {Q}_{e} )\end{matrix}$$

where PublicInv(x,n) computes x⁻¹ mod n, PublicArith(r,h,d,n) computes r+h·d mod n, x(Qₑ) is xₑ, y(Qₑ) is yₑ, and Qₘ is the fourth point on the Montgomery elliptic curve.

Further various embodiments relate to a cryptographic system, including: cryptographic processor with a fixed interface, wherein the cryptographic processor uses a first elliptic curve; and a processor configured to carry out an elliptic curve based cryptographic operation using the cryptographic processor, wherein the processor sends instructions to the cryptographic process to carry out the following steps: converting a second point on a second elliptic curve to a first point on the first elliptic curve using a first function interface of the cryptographic processor and a second function interface of the cryptographic processor; performing a point multiplication on the first point to produce a third point on the first elliptic curve using a point multiplication interface of the cryptographic processor; and converting the third point on the first elliptic curve to a fourth point on the second elliptic curve using the first function interface of the cryptographic processor and the second function interface of the cryptographic processor, wherein the first function interface of the cryptographic processor computes r+h·d mod n where, r, h, d, and n are input values to the first function interface, and wherein the second function interface of the cryptographic processor computes x⁻¹ mod n, where x is an input value to the second function interface.

Various embodiments are described, wherein the first elliptic curve is a Weierstrass elliptic curve and the second elliptic curve is a Montgomery curve.

Various embodiments are described, wherein converting the second point on the second elliptic curve to the first point on the first elliptic curve includes calculating

$$\begin{matrix}{x}_{w} = \frac{{x}_{m}}{{B}_{m}} + \frac{{A}_{m}}{3 {B}_{m}} \\ {y}_{w} = \frac{{y}_{m}}{{B}_{m}}\end{matrix}$$

where x_{w} and y_{w} are the x and y coordinates of the first point on the Weierstrass curve, xₘ and yₘ are the x and y coordinates of the second point on the Montgomery curve and Aₘ and Bₘ are parameters of the Montgomery curve.

Various embodiments are described, wherein computing

$$\begin{matrix}{x}_{w} = \frac{{x}_{m}}{{B}_{m}} + \frac{{A}_{m}}{3 {B}_{m}} \\ {y}_{w} = \frac{{y}_{m}}{{B}_{m}}\end{matrix}$$

$$includes computing$$

$$\begin{matrix}PublicInv ( {B}_{m} , p ) = {B}_{m}^{- 1} mod p \\ PublicInv ( 3 , p ) = {3}^{- 1} mod p \\ PublicArith ( 0 , {3}^{- 1} , {B}_{m}^{- 1} , p ) = {( 3 \cdot {B}_{m} )}^{- 1} mod p \\ PublicArith ( 0 , {A}_{m} , {( 3 {B}_{m} )}^{- 1} , p ) = {A}_{m} \cdot {( 3 \cdot {B}_{m} )}^{- 1} mod p \\ PublicArith ( {A}_{m} \cdot {( 3 \cdot {B}_{m} )}^{- 1} , x ( {P}_{m} ) , {B}_{m}^{- 1} , p ) = x ( {P}_{w} ) \\ PublicArith ( 0 , y ( {P}_{m} ) , {B}_{m}^{- 1} , p ) = y ( {P}_{w} )\end{matrix}$$

where PublicInv(x,n) computes x⁻¹ mod n, PublicArith(r,h,d,n) computes r+h·d mod n, x(P_{w}) is x_{w}, and y(P_{w}) is y_{w}.

Various embodiments are described, wherein converting the third point on the first elliptic curve to the fourth point on the second elliptic curve includes calculating

$$\begin{matrix}{x}_{m} = {B}_{m} \cdot {x}_{w} - \frac{{A}_{m}}{3} \\ {y}_{m} = {B}_{m} \cdot {y}_{w}\end{matrix}$$

where x_{w} and y_{w} are the x and y coordinates of the first point on the Weierstrass curve, xₘ and yₘ are the x and y coordinates of the second point on the Montgomery curve and Aₘ and Bₘ are parameters of the Montgomery curve.

Various embodiments are described, wherein computing

$$\begin{matrix}{x}_{m} = {B}_{m} \cdot {x}_{w} - \frac{{A}_{m}}{3} \\ {y}_{m} = {B}_{m} \cdot {y}_{w}\end{matrix}$$

$$includes computing$$

$$\begin{matrix}PublicArith ( 0 , - 1 , {A}_{m} , p ) = - {A}_{m} mod p \\ PublicArith ( 0 , - {A}_{m} , {3}^{- 1} , p ) = - {A}_{m} \cdot {3}^{- 1} mod p \\ PublicArith ( - {A}_{m} \cdot {3}^{- 1} , x ( {Q}_{w} ) , {B}_{m} , p ) = x ( {Q}_{m} ) \\ PublicArith ( 0 , y ( {Q}_{w} ) , {B}_{m} p ) = y ( {Q}_{m} )\end{matrix}$$

where PublicInv(x,n) computes x⁻¹ mod n, PublicArith(r,h,d,n) computes r+h·d mod n, x(Pₘ) is xₘ, and y(Pₘ) is yₘ.

Various embodiments are described, wherein performing a point multiplication on the first point to produce the third point on the first elliptic curve includes calculating

$${Q}_{w} = r \cdot {P}_{w}$$

where Q_{w} is the third point on the first elliptic curve, P_{w} is the first point on the first elliptic curve, and r is a scalar multiplication value.

Various embodiments are described, further including: converting a fifth point on a third elliptic curve to the second point on the second elliptic curve using the first function interface of the cryptographic processor and the second function interface of the cryptographic processor; and converting the fourth point on the second elliptic curve to a sixth point on the third elliptic curve using the first function interface of the cryptographic processor and the second function interface of the cryptographic processor.

Various embodiments are described, wherein the first elliptic curve is a Weierstrass elliptic curve, the second elliptic curve is a Montgomery elliptic curve, and the third elliptic curve is a Edwards elliptic curve.

Various embodiments are described, wherein converting the fifth point on a third elliptic curve to the second point on the second elliptic curve includes calculating

$$\begin{matrix}{x}_{m} = \frac{1 + {y}_{e}}{1 - {y}_{e}} \\ {y}_{m} = α \cdot \frac{{x}_{m}}{{x}_{e}}\end{matrix}$$

where xₑ and yₑ are the x and y coordinates of the fifth point on the Edwards elliptic curve, xₘ and yₘ are the x and y coordinates of the second point on the Montgomery elliptic curve, and α is a parameter based upon the parameters of the Montgomery and Edwards elliptic curves.

Various embodiments are described, wherein computing

$$\begin{matrix}{x}_{m} = \frac{1 + {y}_{e}}{1 - {y}_{e}} \\ {y}_{m} = α \cdot \frac{{x}_{m}}{{x}_{e}}\end{matrix}$$

$$includes computing$$

$$\begin{matrix}PublicArith ( 1 , - 1 , y ( {P}_{e} ) , p ) = 1 - y ( {P}_{e} ) mod p \\ PublicArith ( 1 , 1 , y ( {P}_{e} ) , p ) = 1 + y ( {P}_{e} ) mod p \\ PublicInv ( 1 - y ( {P}_{e} ) , p ) = {( 1 - y ( {P}_{e} ) )}^{- 1} mod p \\ PublicArith ( 0 , 1 + y ( {P}_{e} ) , {( 1 - y ( {P}_{e} ) )}^{- 1} , p ) = ( 1 + y ( {P}_{e} ) ) {( 1 - y ( {P}_{e} ) )}^{- 1} mod p = x ( {P}_{m} ) \\ PublicArith ( 0 , x ( {P}_{m} ) , {x ( {P}_{e} )}^{- 1} , p ) = x ( {P}_{m} ) \cdot {( x ( {P}_{e} ) )}^{- 1} mod p \\ PublicArith ( 0 , α , x ( {P}_{m} ) \cdot {( x ( {P}_{e} ) )}^{- 1} , p ) = y ( {P}_{m} )\end{matrix}$$

where PublicInv(x,n) computes x⁻¹ mod n, PublicArith(r,h,d,n) computes r+h·d mod n, x(Pₘ) is x_{w}, and y(Pₘ) is yₘ.

Various embodiments are described, wherein converting the fourth point on the second elliptic curve to a sixth point on the third elliptic curve includes calculating

$$\begin{matrix}{x}_{e} = α \cdot \frac{{x}_{m}}{{y}_{m}} \\ {y}_{e} = \frac{{x}_{m} - 1}{{x}_{m} + 1}\end{matrix}$$

where xₑ and yₑ are the x and y coordinates of the first point on the Edwards elliptic curve, xₘ and yₘ are the x and y coordinates of the second point on the Montgomery elliptic curve and α is a parameter based upon the parameters of the Montgomery and Edwards elliptic curves.

Various embodiments are described, wherein computing

$$\begin{matrix}{x}_{e} = α \cdot \frac{{x}_{m}}{{y}_{m}} \\ {y}_{e} = \frac{{x}_{m} - 1}{{x}_{m} + 1}\end{matrix}$$

$$includes computing$$

$$\begin{matrix}PublicInv ( y ( {Q}_{m} ) , p ) = {y ( {Q}_{m} )}^{- 1} mod p \\ PublicArith ( 0 , {y ( {Q}_{m} )}^{- 1} , x ( {Q}_{m} ) , p ) = \frac{x ( {Q}_{m} )}{y ( {Q}_{m} )} \\ PublicArith ( 0 , α , x ( {Q}_{m} ) {y ( {Q}_{m} )}^{- 1} , p ) = \frac{α x ( {Q}_{m} )}{y ( {Q}_{m} )} = x ( {Q}_{e} ) \\ PublicArith ( - 1 , 1 , x ( {Q}_{m} ) , p ) = x ( {Q}_{m} ) - 1 mod p \\ PublicArith ( 1 , 1 , x ( {Q}_{m} ) , p ) = x ( {Q}_{m} ) + 1 mod p \\ PublicInv ( x ( {Q}_{m} ) + 1 , p ) = {( x ( {Q}_{m} ) + 1 )}^{- 1} mod p \\ PublicArith ( 0 , {( x ( {Q}_{m} ) + 1 )}^{- 1} , x ( {Q}_{m} ) - 1 , p ) = y ( {Q}_{e} )\end{matrix}$$

where PublicInv(x,n) computes x⁻¹ mod n, PublicArith(r,h,d,n) computes r+h·d mod n, x(Qₑ) is xₑ, y(Qₑ) is yₑ, and Qₘ is the fourth point on the Montgomery elliptic curve.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 illustrates, in block diagram form, a data processing system including a co-processor for carrying out the point multiplication.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of systems and methods for implementing modern cryptographic primitives with classic cryptographic interfaces will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

Montgomery curve based elliptic curve primitives and twisted Edwards curve based primitives are important new cryptographic primitives that have been standardized by IETF RFC 8032 and RFC 7748 and recently also in FIPS 186-5 and SP800-186. Both are taking state-of-the-art cryptographic developments into account that were not available in 1999 when the first NIST ECC parameters came out. Currently, most of the devices are still implementing and including hardware support for these classical Weierstrass parameters and uptake of the new parameters together with dedicated hardware support and countermeasures will take time.

The aim of this disclosure is to disclose methods that allow a high-level user to implement the newly proposed algorithms based on existing cryptographic capabilities and interfaces thus allowing for interoperability with older products.

Elliptic Curve Cryptography is a versatile tool with many applications in security applications. Without loss of generality, only affine elliptic curve equations will be considered as the representation of coordinates has no impact on methods disclosed herein. Also, only elliptic curves over finite fields GF (q) where q=p^{m} for a prime number p will be considered. More precisely, the focus will be on elliptic curves over prime fields GF(p).

Equation (1) shows the full Weierstrass equation of an elliptic curve (given that the discriminant is non-zero). That means, the elliptic curve consists of all points satisfying (1) together with a point at infinity.

$${y}_{w}^{2} + {a}_{1} {x}_{w} {y}_{w} + {a}_{3} {y}_{w} = {x}_{w}^{3} + {a}_{2} {x}_{w}^{2} + {a}_{4} {x}_{w} + {a}_{6} \qquad ( 1 )$$

Equation (2) is the so called short Weierstrass from of an affine elliptic curve. Any elliptic curve over a finite field with p>3 is isomorphic to a curve in short Weierstrass form.

$${y}_{w}^{2} = {x}_{w}^{3} + {a}_{w} \cdot {x}_{w} + {b}_{w} , \qquad ( 2 )$$

NIST and other standardization bodies issued a set of trustworthy elliptic curve parameters to be used for cryptographic applications. These are either based on prime field curves over GF(p) or binary field curves over GF(2^{m}).

In 2006, Bernstein introduced a key agreement protocol on a slightly different curve (see equation (3) below), a so called Montgomery curve (see Daniel J. Bernstein. Curve25519: New Diffie-Hellman speed records. In Moti Yung, Yevgeniy Dodis, Aggelos Kiayias, and Tal Malkin, editors, Public Key Cryptography-PKC 2006, 9th International Conference on Theory and Practice of Public-Key Cryptography, New York, NY, USA, Apr. 24-26, 2006, Proceedings, volume 3958 of Lecture Notes in Computer Science, pages 207-228. Springer, 2006. doi:10.1007/11745853_14. (Bernstein)).

$${B}_{m} \cdot {y}_{m}^{2} = {x}_{m}^{3} + {A}_{m} \cdot {x}_{m}^{2} + {x}_{m} \qquad ( 3 )$$

Later, a new digital signature algorithm was introduced based on so-called (twisted) Edwards curves (see equation (4) below and Daniel J. Bernstein, Niels Duif, Tanja Lange, Peter Schwabe, and Bo-Yin Yang. High-speed high-security signatures. In Bart Preneel and Tsuyoshi Takagi, editors, Cryptographic Hardware and Embedded Systems—CHES 2011—13th International Workshop, Nara, Japan, Sep. 28-Oct. 1, 2011. Proceedings, volume 6917 of Lecture Notes in Compter Science, pages 124-142. Springer, 2011. doi: 10.1007/978-3-642-23951-9_9).

$${a}_{e} \cdot {x}_{e}^{2} + {y}_{e}^{2} = 1 + {d}_{e} \cdot {x}_{e}^{2} \cdot {y}_{e}^{2} \qquad ( 4 )$$

These newer Montgomery curves and (twisted) Edwards curves can be considered more state-of-the-art in terms of cryptographic principles.

In NIST SP800-186, Appendix B defines several coordinate transformations that allow for the mapping of points between the different curves of equations (2), (3) and (4). This is also described in RFC 7748. Equation (5) shows how to transform any point (apart from few exceptional points like the point at infinity or points where the denominators are zero) from a Montgomery curve to a twisted Edwards curve:

$${x}_{m} = \frac{1 + {y}_{e}}{1 - {y}_{e}} \qquad ( 5 )$$

$${y}_{m} = α \cdot \frac{{x}_{m}}{{x}_{e}}$$

Equation (6) shows how to transform points in the opposite direction.

$${x}_{e} = α \cdot \frac{{x}_{m}}{{y}_{m}} \qquad ( 6 )$$

$${y}_{e} = \frac{{x}_{m} - 1}{{x}_{m} + 1}$$

In both (5) and (6) there is a coefficient α which depends on the concrete curve parameters which are chosen.

Even simpler is the transformation between short Weierstrass and Montgomery curves:

$${x}_{m} = {B}_{m} \cdot {x}_{w} - \frac{{A}_{m}}{3} \qquad ( 7 )$$

$${y}_{m} = {B}_{m} \cdot {y}_{w}$$

The opposite transformation looks like this:

$${x}_{w} = \frac{{x}_{m}}{{B}_{m}} + \frac{{A}_{m}}{3 {B}_{m}} \qquad ( 8 )$$

$${y}_{m} = \frac{{y}_{m}}{{B}_{m}}$$

Of course combining (6) and (7) would allow for the mapping of points from a Weierstrass curve to a twisted Edwards or Edwards curve. All these transformations can be found in NIST. Recommendations for Discrete Logarithm-based Cryptography: Elliptic Curve Domain Parameters, February 2023. URL: https://nvlpubs.nist.gov/nistpubs/SpecialPublications/NIST.SP.800-186.pdf.

It is noted that the transformations (5), (6), (7), and (8) are only one example of bi-rational equivalence. There are other isomorphic representations with slightly different transformations than (5), (6), (7), and (8). The concrete choice does not have an influence on the methods disclosed herein. In general, these affine coordinate transformations always will be rational maps, that means of the form

$$\frac{f}{g} .$$

The procedure outlined in this disclosure can be used to iteratively compute the necessary operations to achieve the transformations of points from one model to another.

The methods disclosed herein provide clear instructions of how to compute the result of a Montgomery based Diffie-Hellman protocol or the result of a scalar multiplication in EdDSA (rB) when only a Weierstrass implementation is available.

Unfortunately, it will very often be the case that an underlying platform cannot be updated because of certification or other reasons. The cryptographic interfaces that the product offers usually only give access to the highest level of cryptographic functionality. This usually includes interfaces for RSA public and private operations, ECDSA sign and verify operations, ECDH key agreement operations, and other operations that usually follow world-wide accepted standards like FIPS 186-5.

The coordinate transformations from equations (5), (6), (7), and (8) above involve low-level modular arithmetic and to be more specific, modular addition, multiplication, and inversion. These functions are very often implemented efficiently in hardware or software inside a security product but not accessible via an interface from a user perspective. They are used internally to implement the above mentioned public interfaces efficiently (and securely).

The methods disclosed herein propose using publicly available interfaces that still allow for the implementation of the transformations.

One such function could be the key-derivation function used in the Qu-Vanstone Implicit Certificate Scheme (ECQV). This function is used during the QV protocol to derive an elliptic curve scalar k₁ from another elliptic curve scalar k₀ by computing k₁=mult·k₀+add2 mod n. This conveniently provides a way to calculate additions and multiplications for the transformation functions described above.

Other public interface functions that can be used in a similar way are for example public interfaces for Schnorr signature generation and ECDAA signature generation. All these public interfaces allow the calculation of a computation of the form s=r+h·d mod n where r, h, d and n can be provided via the interface. So the only thing that is missing is modular inversion in order to compute the maps (5), (6), (7), and (8).

RSA includes a public interface for computing a modular exponentiation m^{e} mod n, usually with parameters of bit-length 2048. Many implementations will also work correctly if provided with inputs of shorter bit-length. Then, the RSA public interface can be readily used to invert an input m by choosing e=p−2 and the modulus n=p for prime-field curves (which are the most widely used). Of course also an RSA private interface with d=p−2 and n=p would be equally suitable.

Note that the maps (5), (6), (7), and (8) are applied to the end result of a scalar multiplication. These results are not considered sensitive in most contexts in terms of side-channel leakage.

The problem solved by the methods disclosed herein allows older products that support classical elliptic curve cryptography based on Weierstrass curves arithmetic to compute new standardized protocols which involve more sophisticated and other parameters and/or arithmetic. Many of these products only allow code on the highest level to be exchanged, without being able to add new calculations. A method is proposed that allows the implementation of these new protocols solely based on reusing existing interfaces that are common in most cryptographic products.

The key feature of the method is that it allows for the implementation of more recent cryptographic algorithms like EdDSA and Curve25519/X448 based key-agreement based on classical elliptic curve functionality. The method implements the conversion between different curve parameter sets via interfaces that are already publicly available and can be re-used for this particular purpose. This is beneficial when the method is implemented on platforms where the underlying primitives cannot be modified anymore where only code can be run that uses the high-level interfaces of the product.

The exact specification of the key-agreement schemes X25519/X448 can be found in IETF. Elliptic Curves for Security, January 2016. URL: https://www.rfc-editor.org/rfc/rfc7748 or in more detail in Bernstein. The details for EdDSA can be found in IETF. Edwards-Curve Digital Signature Algorithm (EdDSA), January 2017. URL: https://www.rfc-editor.org/rfc/rfc8032 and in NIST. FIPS 186-5: Digital Signature Standard (DSS), February 2023. URL: https://nvlpubs.nist.gov/nistpubs/FIPS/NIST.FIPS.186-5.pdf. Currently, the standardized parameter sets are comprised of the Montgomery curves Curve25519 and Curve448, respectively, the (twisted) Edwards curves Ed25519 and Ed448. Note that methods described herein are not limited to these parameter sets.

In all these algorithms, the core curve computation is a scalar multiplication of either the base-point or the public key (point) with a certain scalar value. These scalar multiplications are performed in the respective arithmetic for Montgomery curves or (twisted) Edwards curves.

These new curves come with cryptographic improvements like twist-security, unified addition laws (in the case of (twisted) Edwards curves) or x-coordinate only definitions of the protocol as for X25519 an X448. However, as imposed by NIST in NIST Recommendations for Discrete Logarithm-based Cryptography: Elliptic Curve Domain Parameters, February 2023. URL: https://nvlpubs.nist.gov/nistpubs/SpecialPublications/NIST.SP.800-186.pdf, there are Weierstrass curves that are birationally equivalent to these newly standardized curves. Note that none of the original NIST curves like P-256, etc. have this property. Therefore, NIST included a parameter set W25519 and W448 for two Weierstrass curves equivalent to the curves used for X25519/X448 and Ed25519 and Ed448.

The following assumptions are made. Whether or not the methods disclosed herein can be applied to a certain platform now depends on whether the implementation of the classical ECC component allows the selection of arbitrary parameters for an elliptic curve (i.e., parameters a_{w} and b_{w} in (2) can be chosen by the user) or only select between fixed parameter sets (like NIST curves P-256, Brainpool curves, BSI curve). A second prerequisite is that there is access to a public interface that computes a scalar multiplication on such a Weierstrass curve. This can be a ECDH (Elliptic Curve Diffie-Hellman) interface, or a direct scalar multiplication interface.

$$PublicMult ( r , P ) = r \cdot P \qquad ( 9 )$$

A third prerequisite is a public interface to perform modular arithmetic. This usually is not offered in general to the highest application level as these functions are implemented efficiently and securely on the lower layers of a product. However, one could re-purpose interfaces for other ECC functions for this purpose. In general what is needed is a public interface for a computation

$$PublicArith ( r , h , d , n ) = r + h \cdot d mod n , \qquad ( 10 )$$

where the user can choose r, h, d, n accordingly. Examples of such interfaces would be for example ECQV key derivation, ECDAA-Sign, and Schnorr signature generation.

A fourth prerequisite is the availability of a public interface to perform modular inversion, i.e., division mod n. Again, this is something not usually present at the highest application level. However, for prime moduli n=p, the interfaces for RSA exponentiation (both RSAPublic and RSAPrivate) may be used to perform a so called Euler-inversion. That is, for any given prime number p and an element x, x⁻¹ may be computed as x^{p-2} mod p. Alternatively, equation (10) may be used to implement Euler inversion or the generalized Euclidean algorithm for inversion. In any case, it results in a function

$$PublicInv ( x , n ) = {x}^{- 1} mod n . \qquad ( 11 )$$

For a full EdDSA signature, also the public interface of a cryptographic hash function like SHA-512 or SHAKE-256 needs to be available.

Based on the above assumptions and available public functions, the conversion between Weierstrass parameters and Montgomery parameters and the conversion between Weierstrass and (twisted) Edwards parameters can now be implemented.

The conversion of Montgomery to Weierstrass will first be described in the following steps where x(P) and y(P) denote the x and y coordinate of a given point.

| | |
|---|---|
| 1. | Input: A scalar r and a point Pₘ on a Montgomery curve (3) over a prime field |
| | GF (p). |
| 2. | Convert Pₘ to the corresponding Weierstrass point P_{w} by the following steps: |
| 3. | Compute PublicInv(Bₘ, p) = Bₘ⁻¹ mod p |
| 4. | Compute PublicInv(3, p) = 3⁻¹ mod p |
| 5. | Compute PublicArith(0, 3⁻¹, Bₘ⁻¹, p) = (3 · Bₘ)⁻¹ mod p |
| 6. | Compute PublicArith(0, Aₘ, (3Bₘ)⁻¹, p) = Aₘ · (3 · Bₘ)⁻¹ mod p |
| 7. | Compute PublicArith(Aₘ · (3 · Bₘ)⁻¹, x(Pₘ), Bₘ⁻¹, p) = x(P_{w}) |
| 8. | Compute PublicArith(0, y(Pₘ), Bₘ⁻¹, p) = y(P_{w}) |
| 9. | Compute PublicMult(r, P_{w}) = r · P_{w} = Q_{w} |
| 10. | Compute PublicArith(0, −1, Aₘ, p) = −Aₘ mod p |
| 11. | Compute PublicArith(0, −Aₘ, 3⁻¹, p) = −Aₘ · 3⁻¹ mod p |
| 12. | Compute PublicArith(−Aₘ · 3⁻¹, x(Q_{w}), Bₘ, p) = x(Qₘ) |
| 13. | Compute PublicArith(0, y(Q_{w}), Bₘ, p) = y(Qₘ) |
| 14. | Output: Qₘ = r · Pₘ (or just x(Qₘ) as needed in e.g. X25519 |

Note that the order of computation is not important, only that the needed inputs at a given stage have been computed in a previous stage. Additionally, the computations involving the curve coefficients Aₘ and Bₘ can be pre-computed and stored in memory, thus simplifying the procedure.

The conversion of conversion of (twisted) Edwards to Weierstrass will next be described in the following steps.

| | |
|---|---|
| 1. | Input: A scalar r and a point Pₑ on a (twisted) Edwards curve (4) over a prime field |
| | GF (p). |
| 2. | Convert Pₑ to the corresponding Weierstrass point P_{w} by the following steps: |
| 3. | Compute PublicArith(1, −1, y(Pₑ), p) = 1 − y(Pₑ) mod p |
| 4. | Compute PublicArith(1, 1, y(Pₑ), p) = 1 + y(Pₑ) mod p |
| 5. | Compute PublicInv(1 − y(Pₑ), p) = (1 − y(Pₑ))⁻¹ mod p |
| 6. | Compute PublicArith(0, 1 + y(Pₑ), 1 − y(Pₑ), p) = |
| | (1 + y(Pₑ))(1 − y(Pₑ))⁻¹ mod p = x(Pₘ) |
| 7. | Compute PublicInv(x(Pₑ), p) = x(Pₑ)⁻¹ mod p |
| 8. | Compute PublicArith(0, x(Pₘ), x(Pₑ)⁻¹, p) = x(Pₘ) · (x(Pₑ))⁻¹ mod p |
| 9. | Compute PublicArith(0, α, x(Pₘ) · (x(Pₑ))⁻¹, p) = y(Pₘ) |
| 10. | Convert Pₘ to the corresponding Weierstrass point P_{w} by the following steps: |
| 11. | Compute PublicInv(Bₘ, p) = Bₘ⁻¹ mod p |
| 12. | Compute PublicInv(3, p) = 3⁻¹ mod p |
| 13. | Compute PublicArith(0, 3⁻¹, Bₘ⁻¹, p) = (3 · Bₘ)⁻¹ mod p |
| 14. | Compute PublicArith(0, Aₘ, (3Bₘ)⁻¹, p) = Aₘ · (3 · Bₘ)⁻¹ mod p |
| 15. | Compute PublicArith(Aₘ · (3 · Bₘ)⁻¹, x(Pₘ), Bₘ⁻¹, p) = x(P_{w}) |
| 16. | Compute PublicArith(0, y(Pₘ), Bₘ⁻¹, p) = y(P_{w}) |
| 17. | Compute PublicMult(r, P_{w}) = r · P_{w} = Q_{w} |
| 18. | Compute PublicArith(0, −1, Aₘ, p) = −Aₘ mod p |
| 19. | Compute PublicArith(0, −Aₘ, 3⁻¹, p) = −Aₘ · 3⁻¹ mod p |
| 20. | Compute PublicArith(−Aₘ · 3⁻¹, x(Q_{w}), Bₘ, p) = x(Qₘ) |
| 21. | Compute PublicArith(0, y(Q_{w}), Bₘ, p) = y(Qₘ) |
| 22. | Compute PublicInv(y(Qₘ), p) = y(Qₘ)⁻¹ mod p |
| 23. | Compute PublicArith(0, y(Qₘ)⁻¹, x(Qₘ), p) = x(Qₘ)/y(Qₘ) |
| 24. | Compute PublicArith(0, a, x(Qₘ)y(Qₘ)⁻¹, p) = αx(Qₘ)/y(Qₘ) = x(Qₑ) |
| 25. | Compute PublicArith(−1, 1, x(Qₘ), p) = x(Qₘ) − 1 mod p |
| 26. | Compute PublicArith(1, 1, x(Qₘ), p) = x(Qₘ) + 1 mod p |
| 27. | Compute PublicInv(x(Qₘ) + 1, p) = (x(Qₘ) + 1)⁻¹ mod p |
| 28. | Compute PublicArith(0, (x(Qₘ) + 1)⁻¹, x(Qₘ) − 1, p) = y(Qₑ) |
| 29. | Output: Qₑ = r · Pₑ |

For a full EdDSA signature, one would also need one additional call PublicArith(r,h,s, [symbol] )=S where r is the scalar from before, h is H(Enc(Qₑ)∥Enc(A)∥PH(msg)) represented as an integer and s is an integer derived from the private signing key, [symbol] is the (prime) order of the base point used, and H is a specific cryptographic hash function. It is noted that in this invocation of PublicArith, sensitive data depending on private key bits are entered into the computation where side-channel leakage might be a concern. Also note that the order of computation is not important, only that the needed inputs at a given stage have been computed in a previous stage. Additionally, the computations involving the curve coefficients Aₘ and Bₘ can be pre-computed and stored in memory, thus simplifying the procedure.

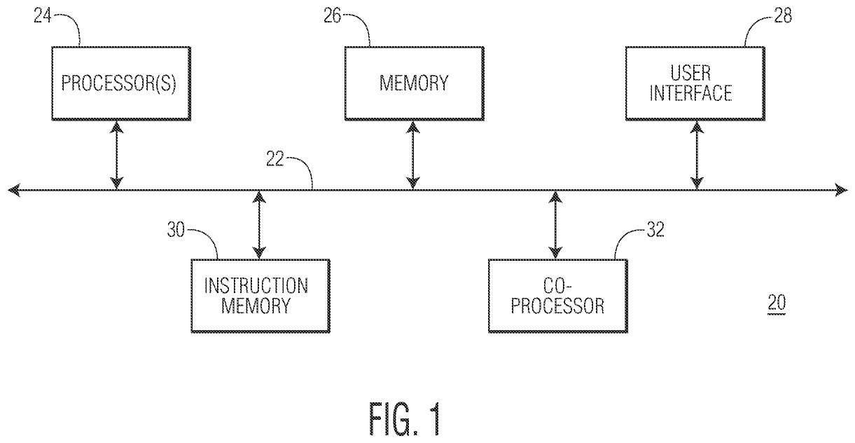

FIG. 1 illustrates, in block diagram form, a data processing system 20 including a co-processor 32 for carrying out the point multiplication. Data processing system 20 may be a system-on-a-chip (SoC) implemented on a single integrated circuit, or it may be a combination of chips. In other embodiments, integrated circuit 10 may include another type of circuit such as an ASIC (application specific integrated circuit), FPGA (field programmable gate array), or the like, that can provide execute instructions. In one embodiment, data processing system 20 may include metal-oxide semiconductor (MOS) transistors fabricated using a conventional complementary metal-oxide semiconductor (CMOS) process. In another embodiment, data processing system 20 may include other transistor types, such as bipolar, and may be manufactured with a different process.

Data processing system 20 includes communication bus 22, processor(s) 24, memory 26, and cryptography co-processor 32. The cryptography co-processor 32 may implement classic cryptography functions that provide public interfaces to securely carry out the direct scalar multiplication (PublicMult), addition and multiplication (PublicArith), and inversion (PublicInv). Bus 22 may be a conventional bus having a plurality of conductors for communicating address, data, and control information. In other embodiments, bus 22 may be an interconnect structure such as, for example, a cross-bar switch or other form of interconnect system. Processor(s) 24 is bi-directionally connected to bus 22. Processor(s) 24 may include one or more of any type of processing element, a processor core, microprocessor, microcontroller, field-programmable gate arrays (FPGAs), application-specific integrated circuits (ASICs), digital signal processor, and the like. There can be any number of processors. The processor 24 may be a secure processor.

Memory 26 is bi-directionally connected to bus 22. Memory 26 can be one or more of any type of volatile or non-volatile memory. Examples of memory types include non-volatile memories such as flash, one-time programmable (OTP), EEPROM (electrically erasable programmable read only memory), and the like. Volatile memory types include static random-access memory (SRAM) and dynamic random-access memory (DRAM). The memory may be used for storing instructions and/or data. Some or all of the memory 26 may be secure memory.

User interface 28 is bi-directionally connected to bus 22 and may be connected to one or more devices for enabling communication with a user such as an administrator. For example, user interface 28 may be enabled for coupling to a display, a mouse, a keyboard, or other input/output device. User interface 28 may also include a network interface having one or more devices for enabling communication with other hardware devices external to data processing system 20.

Instruction memory 30 may include one or more machine-readable storage media for storing instructions for execution by processor(s) 24. In other embodiments, both memories 26 and 30 may store data upon which processor(s) 24 may operate. Memories 26 and 30 may also store, for example, encryption, decryption, and verification applications. Memories 26 and 30 may be implemented in a secure hardware element and may be tamper resistant.

Co-processor 32 is bi-directionally connected to bus 22. Co-processor 32 may be a special type of a co-processor optimized for running encryption/decryption security software according to the RSA, ECC, or Advanced Encryption Standard (AES) or other type of commonly used encryption algorithm. The co-processor 32 may be a HSM that includes secure processing and/or secure memory. Accordingly, and in accordance with the described embodiments, co-processor 32 may be used to efficiently execute instructions for performing the point conversions and multiplication described above. The algorithm executed on co-processor 32 may be used to encrypt/decrypt data and instructions in data processing system 20.

The foregoing disclosure provides illustration and description but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, the term “non-transitory machine-readable storage medium” will be understood to exclude a transitory propagation signal but to include all forms of volatile and non-volatile memory. When software is implemented on a processor, the combination of software and processor becomes a specific dedicated machine.

Because the data processing implementing the embodiments described herein is, for the most part, composed of electronic components and circuits known to those skilled in the art, circuit details will not be explained in any greater extent than that considered necessary as illustrated above, for the understanding and appreciation of the underlying concepts of the aspects described herein and in order not to obfuscate or distract from the teachings of the aspects described herein.

Unless stated otherwise, terms such as “first” and “second” are used to arbitrarily distinguish between the elements such terms describe. Thus, these terms are not necessarily intended to indicate temporal or other prioritization of such elements.

It should be appreciated by those skilled in the art that any block diagrams herein represent conceptual views of illustrative hardware embodying the principles of the aspects.

While each of the embodiments are described above in terms of their structural arrangements, it should be appreciated that the aspects also cover the associated methods of using the embodiments described above.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

1. A method for carrying out an elliptic curve based cryptographic operation using a cryptographic processor with a fixed interface, wherein the cryptographic processor uses a first elliptic curve, comprising:
converting a second point on a second elliptic curve to a first point on the first elliptic curve using a first function interface of the cryptographic processor and a second function interface of the cryptographic processor;
performing a point multiplication on the first point to produce a third point on the first elliptic curve using a point multiplication interface of the cryptographic processor; and
converting the third point on the first elliptic curve to a fourth point on the second elliptic curve using the first function interface of the cryptographic processor and the second function interface of the cryptographic processor,
wherein the first function interface of the cryptographic processor computes r+h·d mod n where, r, h, d, and n are input values to the first function interface, and
wherein the second function interface of the cryptographic processor computes x⁻¹ mod n, where x is an input value to the second function interface.

2. The method of claim 1, wherein the first elliptic curve is a Weierstrass elliptic curve and the second elliptic curve is a Montgomery curve.

3. The method of claim 2, wherein converting the second point on the second elliptic curve to the first point on the first elliptic curve includes calculating
$${x}_{w} = \frac{{x}_{m}}{{B}_{m}} + \frac{{A}_{m}}{3 {B}_{m}}$$
$${y}_{m} = \frac{{y}_{m}}{{B}_{m}}$$
where x_{w} and y_{w} are the x and y coordinates of the first point on the Weierstrass curve, xₘ and yₘ are the x and y coordinates of the second point on the Montgomery curve and Aₘ and Bₘ are parameters of the Montgomery curve.

4. The method of claim 3, wherein computing
$${x}_{w} = \frac{{x}_{m}}{{B}_{m}} + \frac{{A}_{m}}{3 {B}_{m}}$$
$${y}_{m} = \frac{{y}_{m}}{{B}_{m}}$$
$$includes computing$$
$$PublicInv ( {B}_{m} , p ) = {B}_{m}^{- 1} mod p$$
$$Publiclnv ( 3 , p ) = {3}^{- 1} mod p$$
$$PublicArith ( 0 , {3}^{- 1} , {B}_{m}^{- 1} , p ) = {( 3 \cdot {B}_{m} )}^{- 1} mod p$$
$$PublicArith ( 0 , {A}_{m} , {( 3 {B}_{m} )}^{- 1} , p ) = {A}_{m} \cdot {( 3 \cdot {B}_{m} )}^{- 1} mod p$$
$$PublicArith ( {A}_{m} \cdot {( 3 \cdot {B}_{m} )}^{- 1} , x ( {P}_{m} ) , {B}_{m}^{- 1} p ) = x ( {P}_{w} )$$
$$PublicArith ( 0 , y ( {P}_{m} ) , {B}_{m}^{- 1} , p ) = y ( {P}_{w} )$$
where PublicInv(x,n) computes x⁻¹ mod n, PublicArith(r,h,d,n) computes r+h·d mod n, x(P_{w}) is x_{w}, and y(P_{w}) is y_{w}.

5. The method of claim 2, wherein converting the third point on the first elliptic curve to the fourth point on the second elliptic curve includes calculating
$${x}_{m} = {B}_{m} \cdot {x}_{w} - \frac{{A}_{m}}{3}$$
$${y}_{m} = {B}_{m} \cdot {y}_{w}$$
where x_{w} and y_{w} are the x and y coordinates of the first point on the Weierstrass curve, xₘ and yₘ are the x and y coordinates of the second point on the Montgomery curve and Aₘ and Bₘ are parameters of the Montgomery curve.

6. The method of claim 5, wherein computing
$$\begin{matrix}{x}_{m} = {B}_{m} \cdot {x}_{w} - \frac{{A}_{m}}{3} \\ {y}_{m} = {B}_{m} \cdot {y}_{w}\end{matrix}$$
$$includes computing$$
$$PublicArith ( 0 , - 1 , {A}_{m} , p ) = - {A}_{m} mod p$$
$$PublicArith ( 0 , - {A}_{m} , {3}^{- 1} , p ) = - {A}_{m} \cdot {3}^{- 1} mod p$$
$$PublicArith ( - {A}_{m} \cdot {3}^{- 1} , x ( {Q}_{w} ) , {B}_{m} , p ) = x ( {Q}_{m} )$$
$$PublicArith ( 0 , y ( {Q}_{w} ) , {B}_{m} , p ) = y ( {Q}_{m} )$$
where PublicInv(x,n) computes x⁻¹ mod n, PublicArith(r,h,d,n) computes r+h·d mod n, x(Pₘ) is xₘ, and y(Pₘ) is yₘ.

7. The method of claim 1, wherein performing a point multiplication on the first point to produce the third point on the first elliptic curve includes calculating
$${Q}_{w} = r \cdot {P}_{w}$$
where Q_{w} is the third point on the first elliptic curve, P_{w} is the first point on the first elliptic curve, and r is a scalar multiplication value.

8. The method of claim 1, further comprising:
converting a fifth point on a third elliptic curve to the second point on the second elliptic curve using the first function interface of the cryptographic processor and the second function interface of the cryptographic processor; and
converting the fourth point on the second elliptic curve to a sixth point on the third elliptic curve using the first function interface of the cryptographic processor and the second function interface of the cryptographic processor.

9. The method of claim 8, wherein the first elliptic curve is a Weierstrass elliptic curve, the second elliptic curve is a Montgomery elliptic curve, and the third elliptic curve is a Edwards elliptic curve.

10. The method of claim 9, wherein converting the fifth point on a third elliptic curve to the second point on the second elliptic curve includes calculating
$$\begin{matrix}{x}_{m} = \frac{1 + {y}_{e}}{1 - {y}_{e}} \\ {y}_{m} = α \cdot \frac{{x}_{m}}{{x}_{e}}\end{matrix}$$
where xₑ and yₑ are the x and y coordinates of the fifth point on the Edwards elliptic curve, xₘ and yₘ are the x and y coordinates of the second point on the Montgomery elliptic curve and α is a parameter based upon the parameters of the Montgomery and Edwards elliptic curves.

11. The method of claim 10, wherein computing
$$\begin{matrix}{x}_{m} = \frac{1 + {y}_{e}}{1 - {y}_{e}} \\ {y}_{m} = α \cdot \frac{{x}_{m}}{{x}_{e}}\end{matrix}$$
$$includes computing$$
$$PublicArith ( 1 , - 1 , y ( {P}_{e} ) , p ) = 1 - y ( {P}_{e} ) mod p$$
$$PublicArith ( 1 , 1 , y ( {P}_{e} ) , p ) = 1 + y ( {P}_{e} ) mod p$$
$${PublicInv ( 1 , y ( {P}_{e} ) , p ) = 1 - y ( {P}_{e} ) )}^{- 1} mod p$$
$$PublicArith ( 0 , 1 , y ( {P}_{e} ) , {( 1 - y ( {P}_{e} ) )}^{- 1} , p ) = ( 1 + y ( {P}_{e} ) ) {( 1 - y ( {P}_{e} ) )}^{- 1} mod p = x ( {P}_{m} )$$
$$PublicArith ( 0 , x ( {P}_{m} ) , {x ( {P}_{e} )}^{- 1} , p = x ( {P}_{m} ) \cdot {( x ( {P}_{e} ) )}^{- 1} mod p$$
$$PublicArith ( 0 , α , x ( {P}_{m} ) \cdot {( x ( {P}_{e} ) )}^{- 1} , p ) = y ( {P}_{m} )$$
where PublicInv(x,n) computes x⁻¹ mod n, PublicArith(r,h,d,n) computes r+h·d mod n, x(Pₘ) is x_{w}, and y(Pₘ) is yₘ.

12. The method of claim 9, wherein converting the fourth point on the second elliptic curve to a sixth point on the third elliptic curve includes calculating
$$\begin{matrix}{x}_{e} = α \cdot \frac{{x}_{m}}{{y}_{m}} \\ {y}_{e} = α \cdot \frac{{x}_{m} - 1}{{x}_{m} + 1}\end{matrix}$$
where xₑ and yₑ are the x and y coordinates of the first point on the Edwards elliptic curve, xₘ and yₘ are the x and y coordinates of the second point on the Montgomery elliptic curve, and α is a parameter based upon the parameters of the Montgomery and Edwards elliptic curves.

13. The method of claim 12, wherein computing
$$\begin{matrix}{x}_{e} = α \cdot \frac{{x}_{m}}{{y}_{m}} \\ {y}_{e} = \frac{{x}_{m} - 1}{{x}_{m} + 1}\end{matrix}$$
$$includes computing$$
$$PublicInv ( y ( {Q}_{m} ) , p ) = {y ( {Q}_{m} )}^{- 1} mod p$$
$$PublicArith ( 0 , {y ( {Q}_{m} )}^{- 1} , x ( {Q}_{m} ) , p ) = \frac{x ( {Q}_{m} )}{y ( {Q}_{m} )}$$
$$PublicArith ( 0 , α , x ( {Q}_{m} ) {y ( {Q}_{m} )}^{- 1} , p ) = \frac{α x ( {Q}_{m} )}{y ( {Q}_{m} )} = x ( {Q}_{e} )$$
$$PublicArith ( - 1 , 1 , x ( {Q}_{m} ) , p ) = x ( {Q}_{m} ) - 1 mod p$$
$$PublicArith ( 1 , 1 , x ( {Q}_{m} ) , p ) = x ( {Q}_{m} ) + 1 mod p$$
$${PublicInv ( x ( {Q}_{m} ) + 1 , p ) = x ( {Q}_{m} ) + 1 )}^{- 1} mod p$$
$$PublicArith ( 0 , {( x ( {Q}_{m} ) + 1 )}^{- 1} , x ( {Q}_{m} ) - 1 , p ) = y ( {Q}_{e} )$$
where PublicInv(x,n) computes x⁻¹ mod n, PublicArith(r,h,d,n) computes r+h·d mod n, x(Qₑ) is xₑ, y(Qₑ) is yₑ, and Qₘ is the fourth point on the Montgomery elliptic curve.

14. A cryptographic system, comprising:
cryptographic processor with a fixed interface, wherein the cryptographic processor uses a first elliptic curve; and
a processor configured to carry out an elliptic curve based cryptographic operation using the cryptographic processor, wherein the processor sends instructions to the cryptographic process to carry out the following steps:
converting a second point on a second elliptic curve to a first point on the first elliptic curve using a first function interface of the cryptographic processor and a second function interface of the cryptographic processor;
performing a point multiplication on the first point to produce a third point on the first elliptic curve using a point multiplication interface of the cryptographic processor; and
converting the third point on the first elliptic curve to a fourth point on the second elliptic curve using the first function interface of the cryptographic processor and the second function interface of the cryptographic processor,
wherein the first function interface of the cryptographic processor computes r+h·d mod n where, r, h, d, and n are input values to the first function interface, and
wherein the second function interface of the cryptographic processor computes x⁻¹ mod n, where x is an input value to the second function interface.

15. The system of claim 14, wherein the first elliptic curve is a Weierstrass elliptic curve and the second elliptic curve is a Montgomery curve.

16. The system of claim 15, wherein converting the second point on the second elliptic curve to the first point on the first elliptic curve includes calculating
$$\begin{matrix}{x}_{w} = \frac{{x}_{m}}{{B}_{m}} + \frac{{A}_{m}}{3 {B}_{m}} \\ {y}_{w} = \frac{{y}_{m}}{{B}_{m}}\end{matrix}$$
where x_{w} and y_{w} are the x and y coordinates of the first point on the Weierstrass curve, xₘ and yₘ are the x and y coordinates of the second point on the Montgomery curve and Aₘ and Bₘ are parameters of the Montgomery curve.

17. The system of claim 16, wherein computing
$$\begin{matrix}{x}_{w} = \frac{{x}_{m}}{{B}_{m}} + \frac{{A}_{m}}{3 {B}_{m}} \\ {y}_{w} = \frac{{y}_{m}}{{B}_{m}}\end{matrix}$$
$$includes computing$$
$$PublicInv ( {B}_{m} , p ) = {B}_{m}^{- 1} mod p$$
$$PublicInv ( 3 , p ) = {3}^{- 1} mod p$$
$$PublicArith ( 0 , {3}^{- 1} , {B}_{m}^{- 1} , p ) = {( 3 \cdot {B}_{m} )}^{- 1} mod p$$
$$PublicArith ( 0 , {A}_{m} , {( 3 {B}_{m} )}^{- 1} , p ) = {A}_{m} \cdot {( 3 \cdot {B}_{m} )}^{- 1} mod p$$
$$PublicArith ( {A}_{m} \cdot {( 3 \cdot {B}_{m} )}^{- 1} , x ( {P}_{m} ) , {B}_{m}^{- 1} , p ) = x ( {P}_{w} )$$
$$PublicArith ( 0 , y ( {P}_{m} ) , {B}_{m}^{- 1} , p ) = y ( {P}_{w} )$$
where PublicInv(x,n) computes x⁻¹ mod n, PublicArith(r,h,d,n) computes r+h·d mod n, x(P_{w}) is x_{w}, and y(P_{w}) is y_{w}.

18. The system of claim 15, wherein converting the third point on the first elliptic curve to the fourth point on the second elliptic curve includes calculating
$$\begin{matrix}{x}_{m} = {B}_{m} \cdot {x}_{w} - \frac{{A}_{m}}{3} \\ {y}_{m} = {B}_{m} \cdot {y}_{w}\end{matrix}$$
where x_{w} and y_{w} are the x and y coordinates of the first point on the Weierstrass curve, xₘ and yₘ are the x and y coordinates of the second point on the Montgomery curve and Aₘ and Bₘ are parameters of the Montgomery curve.

19. The system of claim 18, wherein computing
$$\begin{matrix}{x}_{m} = {B}_{m} \cdot {x}_{w} - \frac{{A}_{m}}{3} \\ {y}_{m} = {B}_{m} \cdot {y}_{w}\end{matrix}$$
$$includes computing$$
$$PublicArith ( 0 , - 1 , {A}_{m} , p ) = - {A}_{m} mod p$$
$$PublicArith ( 0 , - {A}_{m} , {3}^{- 1} , p ) = - {A}_{m} \cdot {3}^{- 1} mod p$$
$$PublicArith ( - {A}_{m} \cdot {3}^{- 1} , x ( {Q}_{w} ) , {B}_{m} , p = x ( {Q}_{m} )$$
$$PublicArith ( 0 , y ( {Q}_{w} ) , {B}_{m} , p ) = y ( {Q}_{m} )$$
where PublicInv(x,n) computes x⁻¹ mod n, PublicArith(r,h,d,n) computes r+h·d mod n, x(Pₘ) is xₘ, and y(Pₘ) is yₘ.

20. The system of claim 14, wherein performing a point multiplication on the first point to produce the third point on the first elliptic curve includes calculating
$${Q}_{w} = r \cdot {P}_{w}$$
where Q_{w} is the third point on the first elliptic curve, P_{w} is the first point on the first elliptic curve, and r is a scalar multiplication value.

21. The system of claim 14, further comprising:
converting a fifth point on a third elliptic curve to the second point on the second elliptic curve using the first function interface of the cryptographic processor and the second function interface of the cryptographic processor; and
converting the fourth point on the second elliptic curve to a sixth point on the third elliptic curve using the first function interface of the cryptographic processor and the second function interface of the cryptographic processor.

22. The system of claim 21, wherein the first elliptic curve is a Weierstrass elliptic curve, the second elliptic curve is a Montgomery elliptic curve, and the third elliptic curve is a Edwards elliptic curve.

23. The system of claim 22, wherein converting the fifth point on a third elliptic curve to the second point on the second elliptic curve includes calculating
$$\begin{matrix}{x}_{m} = \frac{1 + {y}_{e}}{1 - {y}_{e}} \\ {y}_{m} = α \cdot \frac{{x}_{m}}{{x}_{e}}\end{matrix}$$
where xₑ and yₑ are the x and y coordinates of the fifth point on the Edwards elliptic curve, xₘ and yₘ are the x and y coordinates of the second point on the Montgomery elliptic curve, and a is a parameter based upon the parameters of the Montgomery and Edwards elliptic curves.

24. The system of claim 23, wherein computing
$$\begin{matrix}{x}_{m} = \frac{1 + {y}_{e}}{1 - {y}_{e}} \\ {y}_{m} = α \cdot \frac{{x}_{m}}{{x}_{e}}\end{matrix}$$
$$includes computing$$
$$PublicArith ( 1 , - 1 , y ( {P}_{e} ) , p ) = 1 - y ( {P}_{e} ) mod p$$
$$PublicArith ( 1 , 1 , y ( {P}_{e} ) , p ) = 1 + y ( {P}_{e} ) mod p$$
$$PublicInv ( 1 - y ( {P}_{e} ) , p ) = {( 1 - y ( {P}_{e} ) )}^{- 1} mod p$$
$$PublicArith ( 0 , 1 + y ( {P}_{e} ) , {( 1 - y ( {P}_{e} ) )}^{- 1} , p ) = ( 1 + y ( {P}_{e} ) ) ( {( 1 - y ( {P}_{e} ) )}^{- 1} mod p = x ( {P}_{m} )$$
$${PublicArith ( 0 , x ( {P}_{m} ) , {x ( {P}_{e} )}^{- 1} , p ) = x ( {P}_{m} ) \cdot x ( {P}_{e} ) )}^{- 1} mod p$$
$$PublicArith ( 0 , α , x ( {P}_{m} ) \cdot {( x ( {P}_{e} ) )}^{- 1} , p ) = y ( {P}_{m} )$$
where PublicInv(x,n) computes x⁻¹ mod n, PublicArith(r,h,d,n) computes r+h·d mod n, x(Pₘ) is x_{w}, and y(Pₘ) is yₘ.

25. The system of claim 24, wherein converting the fourth point on the second elliptic curve to a sixth point on the third elliptic curve includes calculating
$$\begin{matrix}{x}_{e} = α \cdot \frac{{x}_{m}}{{y}_{m}} \\ {y}_{e} = \frac{{x}_{m} - 1}{{x}_{m} + 1}\end{matrix}$$
where xₑ and yₑ are the x and y coordinates of the first point on the Edwards elliptic curve, xₘ and yₘ are the x and y coordinates of the second point on the Montgomery elliptic curve and α is a parameter based upon the parameters of the Montgomery and Edwards elliptic curves.

26. The system of claim 25, wherein computing
$$\begin{matrix}{x}_{e} = α \cdot \frac{{x}_{m}}{{y}_{m}} \\ {y}_{e} = \frac{{x}_{m} - 1}{{x}_{m} + 1}\end{matrix}$$
$$includes computing$$
$$PublicInv ( y ( {Q}_{m} ) , p ) = {y ( {Q}_{m} )}^{- 1} mod p$$
$$PublicArith ( 0 , {y ( {Q}_{m} )}^{- 1} , x ( {Q}_{m} ) , p ) = \frac{x ( {Q}_{m} )}{y ( {Q}_{m} )}$$
$$PublicArith ( 0 , α , x ( {Q}_{m} ) {y ( {Q}_{m} )}^{- 1} , p ) = \frac{α x ( {Q}_{m} )}{y ( {Q}_{m} )} = x ( {Q}_{e} )$$
$$PublicArith ( - 1 , 1 , x ( {Q}_{m} ) , p ) = x ( {Q}_{m} ) - 1 mod p$$
$$PublicArith ( 1 , 1 , x ( {Q}_{m} ) , p ) = x ( {Q}_{m} ) + 1 mod p$$
$$PublicInv ( x ( {Q}_{m} ) + 1 , p ) = {( x ( {Q}_{m} ) + 1 )}^{- 1} mod p$$
$$PublicArith ( 0 , {( x ( {Q}_{m} ) + 1 )}^{- 1} , x ( {Q}_{m} ) - 1 , p ) = y ( {Q}_{e} )$$
where PublicInv(x,n) computes x⁻¹ mod n, PublicArith(r,h,d,n) computes r+h·d mod n, x(Qₑ) is xₑ, y(Qₑ) is yₑ, and Qₘ is the fourth point on the Montgomery elliptic curve.
